(19) United States
(12) Patent Application Publication
(10) Pub. No.: US 2026/0239048 A1
(43) Pub. Date: Aug. 13, 2026

(54) Channel Quality Indicator Feedback

(71) Applicant: Fraunhofer-Gesellschaft zur Förderung der angewandten Forschung e.V., MÜNCHEN (DE)

(72) Inventors: Marcus Grossmann, Erlangen (DE); Sutharshun Varatharaajan, Erlangen (DE); Markus Landmann, Erlangen (DE); Ebrahim Amiri, Erlangen (DE); Alexander Götz, Erlangen (DE)

(73) Assignee: Fraunhofer-Gesellschaft zur Förderung der angewandten Forschung e.V., MÜNCHEN (DE)

(21) Appl. No.: 19/154,587

(22) PCT Filed: Jan. 31, 2024
(86) PCT No.: PCT/EP2024/052312

§ 371 Date: Aug. 7, 2025

(30) Foreign Application Priority Data
Feb. 8, 2022 (EP) 23155690.3

(51) Int. Cl. H04W 24/08; H04W 24/10

(52) U.S. Cl. CPC H04W 24/08; H04W 24/10

(57) ABSTRACT

The present disclosure herein relates to methods and apparatuses for CSI reporting. A method performed by a wireless device (800) the method comprises: receiving (501), from a network node or another wireless device a CSI report configuration, performing (502) measurement(s) of one or more downlink reference signal resource(s) provided by the CSI report configuration, determining (503) an encoded channel state information, CSI, using at least said measurement(s), determining (504) a decoded CSI corresponding to said encoded CSI, determining (505) at least one CQI value calculated using said decoded CSI, and transmitting (506) to the network node or to said another wireless device, a CSI report comprising said at least one CQI value. There are also described methods performed by the wireless device (800), and also methods performed by a network node (1200).

### TECHNICAL FIELD

The present disclosure relates to the field of wireless communications, and in particular to methods and apparatuses for Channel State Information (CSI) feedback including channel quality indicator reporting for wireless devices employing in a wireless communications network such as advanced 5G networks.

### BACKGROUND

The fifth generation (5G) mobile communications system also known as new radio (NR) provides a higher level of performance than the previous generations of mobile communications system. 5G mobile communications has been driven by the need to provide ubiquitous connectivity for applications as diverse automotive communication, remote control with feedback, video downloads, as well as data applications for Internet-of-Things (IoT) devices, machine type communication (MTC) devices, etc. 5G wireless technology brings several main benefits, such as faster speed, shorter delays and increased connectivity. The third-generation partnership project (3GPP) provides the complete system specification for the 5G network architecture, which includes at least a radio access network (RAN), core transport networks (CN) and service capabilities.

FIG. 1 illustrates a simplified schematic view of an example of a wireless communications network 100 including a core network (CN) 110 and a radio access network (RAN) 120. The RAN 120 is shown including a plurality of network nodes or radio base stations, which in 5G are called gNBs. Three radio base stations are depicted gNB1, gNB2 and gNB3. Each gNB serves an area called a coverage area or a cell. FIG. 1 illustrates 3 cells 121, 122 and 123, each served by its own gNB, gNB1, gNB2 and gNB3, respectively. It should be mentioned that the network 100 may include any number of cells and gNBs. The radio base stations, or network nodes serve users within a cell. In 4G or LTE, a radio base station is called an eNB, in 3G or UMTS, a radio base station is called an eNodeB, and BS in other radio access technologies. A user or a user equipment (UE) may be a wireless or a mobile terminal device or a stationary communication device. A mobile terminal device or a UE may also be an IoT device, an MTC device, etc. IoT devices may include wireless sensors, software, actuators, and computer devices. They can be imbedded into mobile devices, motor vehicle, industrial equipment, environmental sensors, medical devices, aerial vehicles and more, as well as network connectivity that enables these devices to collect and exchange data across an existing network infrastructure.

Referring back to FIG. 1, each cell is shown including UEs and IoT devices. gNB1 in cell 121 serves UE1 121A, UE2 121B and IoT device 121C. Similarly, gNB2 in cell 121 serves UE3 122A, UE4 122B and IoT device 122C, and gNB3 in cell 123 serves UE5 123A, UE6 123B and IoT device 123C. The network 100 may include any number of UEs and IoT devices or any other types of devices. The devices communicate with the serving gNB(s) in the uplink and the gNB(s) communicate with the devices in the downlink. The respective base station gNB1 to gNB3 may be connected to the CN 120, e.g., via the S1 interface, via respective backhaul links 111, 121D, 122D, 123D, which are schematically depicted in FIG. 1 by the arrows pointing to “core”. The core network 120 may be connected to one or more external networks, such as the Internet. The gNBs may be connected to each other via the S1 interface or the X2 interface or the XN interface in 5G, via respective interface links 121E, 122E and 123E, which is depicted in the figure by the arrows pointing to gNBs.

For data transmission, a physical resource grid may be used. The physical resource grid may comprise a set of resource elements (REs) to which various physical channels and physical signals are mapped. For example, the physical channels may include the physical downlink, uplink and/or sidelink (SL) shared channels (PDSCH, PUSCH, PSSCH) carrying user specific data, also referred to as downlink, uplink or sidelink payload data, the physical broadcast channel (PBCH) carrying for example a master information block (MIB) and a system information block (SIB), the physical downlink, uplink and/or sidelink control channels (PDCCH, PUCCH, PSCCH) carrying for example the downlink control information (DCI), the uplink control information (UCI) or the sidelink control information (SCI). For the uplink, the physical channels may further include the physical random-access channel (PRACH or RACH) used by UEs for accessing the network once a UE is synchronized and obtains the MIB and SIB. The physical signals may comprise reference signals (RS), synchronization signals (SSs) and the like. The resource grid may comprise a frame or radio frame having a certain duration, like 10 milliseconds, in the time domain and having a given bandwidth in the frequency domain. The radio frame may have a certain number of subframes of a predefined length, e.g., 2 subframes with a length of 1 millisecond. Each subframe may include two slots of a number of OFDM symbols depending on the cyclic prefix (CP) length. In 5G, each slot consists of 14 OFDM symbols or 12 OFDM symbols based on normal CP and extended CP respectively. A frame may also consist of a smaller number of OFDM symbols, e.g., when utilizing shortened transmission time intervals (TTIs) or a mini-slot/non-slot-based frame structure comprising just a few OFDM symbols. Slot aggregation is supported in 5G NR and hence data transmission can be scheduled to span one or multiple slots. Slot format indication informs a UE whether an OFDM symbol is downlink, uplink or flexible.

The wireless communication network system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g., DFT-OFDM. Other waveforms, like non-orthogonal waveforms for multiple access, e.g., filter-bank multicarrier (FBMC), generalized frequency division multiplexing (GFDM) or universal filtered multi carrier (UFMC), may be used. The wireless communication system may operate, e.g., in accordance with the LTE-Advanced pro standard or the 5G or NR (New Radio) standard.

The wireless communications network system depicted in FIG. 1 may be a heterogeneous network having two distinct overlaid networks, a network of macro cells with each macro cell including a macro base station, like base station gNB1 to gNB3, and a network of small cell base stations (not shown in FIG. 1), like femto- or pico-base stations. In addition to the above described wireless network also non-terrestrial wireless communication networks exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-advanced pro standard or the 5G or NR, standard.

In the wireless communications network system as described above, such as LTE or New Radio (5G), downlink signals convey data signals, control signals containing downlink, DL, control information (DCI), and a number of reference signals or symbols (RS) used for different purposes. A gNodeB (or gNB or base station) transmits data and downlink control information (DCI) through the so-called physical downlink shared channel (PDSCH) and physical downlink control channel (PDCCH) or enhanced PDCCH (ePDCCH), respectively. Moreover, the downlink signal(s) of the gNB may contain one or multiple types of reference signals (RSs) including a common/cell-specific RS (CRS) in LTE, a channel state information RS (CSI-RS), synchronization signals, a demodulation RS (DM-RS), and a phase tracking RS (PT-RS). The CRS is transmitted over a DL system bandwidth part and used at the user equipment (UE) to obtain a channel estimate to demodulate the data or control information. The CSI-RS is transmitted with a reduced density in the time and frequency domain compared to CRS and used at the UE for channel estimation or for channel state information (CSI) acquisition. The synchronization signals (SS) which can be further classified into primary and secondary synchronization signals (PSS/SSS) are transmitted along with the physical broadcast channel (PBCH) as a SS/PBCH block or a SS block (SSB). The SSs or the SSBs as a whole are used for frame synchronization in the DL, cell selection, initial access and/or beam management, among other purposes. The DM-RS is transmitted along with the PDSCH, PDCCH and/or PBCH, which is then used by the UE for data demodulation.

In the wireless communications network system such as the one depicted schematically in FIG. 1, multi-antenna techniques may be used, e.g., in accordance with LTE, NR or any other communication system, to improve user data rates, link reliability, cell coverage and network capacity. To support multi-stream or multi-layer transmissions, linear precoding is used in the physical layer of the communication system. Linear precoding is performed by a precoder matrix which maps layers of data to antenna ports. The precoding may be seen as a generalization of beamforming, which is a technique to spatially direct or focus a data transmission towards an intended receiver. The precoder matrix to be used at the gNB to map the data to the transmit antenna ports is decided using channel state information, CSI.

For signal precoding at the gNB, the channel state information is either reported or fed back from a user equipment (wireless device served by the gNB) and/or acquired from measurements of UL channel from reference signals transmitted by the UE.

Artificial Intelligence (AI)/Machine Learning (ML) models such as neural networks are widely regarded as an efficient way to compress or to predict channel state information, CSI, compared to the current 3GPP LTE or NR. The accuracy of channel state information is crucial for a network in providing performance guarantees and in making scheduling decisions. This invention disclosure deals with the computation and reporting of a CSI parameter called the channel quality index/indicator, CQI, whose reliability/accuracy is affected due to CSI compression or prediction using for example AI/ML models or any other linear or non-linear methods/mapping e.g., methods wherein at least one or more of the CSI parameters/coefficients may not be based on discrete representation(s). CSI compression or prediction involving singular/eigen-value decomposition and/or Kalman/Wiener-filtering to represent channel or precoder information, which may also use one or more basis sets for said compression or prediction, can provide such CSI.

### SUMMARY

It is an objective of the embodiments herein to provide methods and apparatuses for CSI feedback reporting for a precoding in a wireless communications network such as advanced 5G networks.

According to an aspect of some embodiments herein, there is provided a method performed by a wireless device (800) (or user equipment) for channel state information, CSI, reporting, in a wireless communication system, the method comprising:
receiving (501), from a network node or another wireless device, a channel state information, CSI, report configuration,
performing (502) measurement(s) of one or more downlink reference signal resource(s) provided by the CSI report configuration,
determining (503) an encoded channel state information, CSI, using at least said measurement(s),
determining (504) a decoded CSI corresponding to said encoded CSI,
determining (505) at least one CQI value calculated using said decoded CSI,
transmitting (506) to a network node or another wireless device, a CSI report comprising said at least one CQI value.

According to an aspect of some embodiments herein, there is provided a method performed by a wireless device (800) (or user equipment) for channel state information, CSI, reporting, in a wireless communication system, the method comprising:
receiving (601), from a network node, a channel state information, CSI, report configuration,
performing (602) measurement(s) of one or more downlink, DL, reference signal resource(s) provided by the CSI report configuration,
determining (603) an encoded channel state information, CSI, using at least the measurement(s) of the one or more DL RS(s),
determining (604) a first CQI value using the encoded CSI, determining (605) a reference CSI using the measurement(s) of the one or more DL RS(s),
determining (606) a second CQI value using the reference CSI,
reporting or transmitting (607) to a network node, a CSI report comprising information related to the first CQI value and the second CQI value.

According to an aspect of some embodiments herein, there is provided a method performed by a wireless device (800) (or user equipment) for channel state information, CSI, reporting, in a wireless communication system, the method comprising:
receiving (701), from a network node, a channel state information, CSI, report configuration,
performing (702) measurement(s) of one or more downlink reference signal resource(s) provided by the CSI report configuration,
determining (703) an encoded channel state information, CSI, using at least the measurement(s) from one or more DL RS(s),
determining (704) at least one channel quality index/index, CQI, value using the value(s) of at least one CQI correction parameter,
transmitting (705) to the network node or any other communication entity or wireless device, a CSI report comprising said at least one CQI value.

According to an aspect of some embodiments herein, there is provided a method performed by a network node (1200) for receiving, from a wireless device (800), a channel state information, CSI, report in a wireless communication system, the method comprising:
transmitting (901), to the wireless device, a CSI report configuration; for enabling the wireless device to perform the following:
   performing measurement(s) of one or more downlink reference signal resource(s) provided by the CSI report configuration,
   determining an encoded channel state information, CSI, using at least said measurement(s),
   determining a decoded CSI corresponding to said encoded CSI,
   determining at least one CQI value calculated using said decoded CSI,
   generate a CSI report for transmission to the network node comprising said at least one CQI value,
receiving (902), from the wireless device an uplink control information (UCI) including the CSI report over an uplink, UL, channel.

According to an aspect of some embodiments herein, there is provided a method performed by a network node (1200) for receiving, from a wireless device (800), a channel state information, CSI, report in a wireless communication system, the method comprising:
transmitting (1001), to the wireless device, a CSI report configuration; for enabling the wireless device to perform the following:
   performing measurement(s) of one or more downlink, DL, reference signal resource(s) provided by the CSI report configuration,
   determining an encoded channel state information, CSI, using at least the measurement(s) of the one or more DL RS(s),
   determining a first CQI value using the encoded CSI,
   determining a reference CSI using the measurement(s) of the one or more DL RS(s),
   determining a second CQI value using the reference CSI,
   generate a CSI report for transmission to the network node, the CSI report comprising information related to the first CQI value and the second CQI value, and
receiving (1002), from the wireless device an uplink control information (UCI) including the CSI report over an uplink, UL, channel.

According to an aspect of some embodiments herein, there is provided a method performed by a network node (1200) for receiving, from a wireless device (800), a channel state information, CSI, report in a wireless communication system, the method comprising:
transmitting (1101), to the wireless device, a CSI report configuration; for enabling the wireless device to:
   performing measurement(s) of one or more downlink reference signal resource(s) provided by the CSI report configuration,
   determining an encoded channel state information, CSI, using at least the measurement(s) from one or more DL RS(s),
   determining at least one channel quality index/index, CQI, value using the value(s) of at least one CQI correction parameter,
   generate a CSI report for transmission to the network node, the CSI report comprising said at least one CQI value, and
receiving (1102), from the wireless device an uplink control information (UCI) including the CSI report over an uplink, UL, channel.

According to another aspect of embodiments herein, there is also provided a wireless device or UE comprising a processor and a memory containing instructions executable by the processor, whereby said UE is operative or configured to perform any one of the embodiments presented in the detailed description related to the actions performed by the wireless device, such as in method claims 1-3.

According to yet another aspect of embodiments herein, there is also provided a network node comprising a processor and a memory containing instructions executable by the processor, whereby said network node is operative or configured to perform any one of the embodiments presented in the detailed description related to the network node, such as in at least method claim 21-23.

There is also provided a computer program comprising instructions which when executed on at least one processor of the wireless device (UE), causes the at least said one processor to carry out the actions or method steps presented herein.

There is also provided a computer program comprising instructions which when executed on at least one processor of the network node, causes the at least said one processor to carry out the method steps presented herein.

A carrier is also provided containing the computer program, wherein the carrier is one of a computer readable storage medium, an electronic signal, optical signal, or a radio signal.

An advantage of the embodiments herein is to significantly reduce the feedback overhead and the computational complexity at the wireless device for A//ML-based CSI reporting from a wireless device (e.g., a UE) to a network node or another wireless device. Another advantage is to reduce latency of the CSI reporting.

Additional advantages of the embodiments herein are provided in the detailed description of this disclosure.

### BRIEF DESCRIPTION OF THE DRAWINGS

Embodiments of the present invention are now described in further detail with reference to the accompanying drawings, in which:

FIG. 1 shows a schematic representation of a wireless communications system;

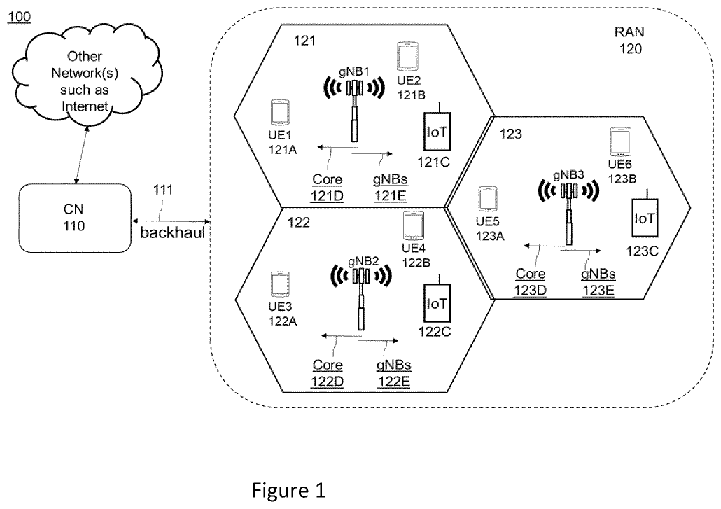

FIG. 2 shows a schematic representation of a DL transmission using a codebook-based-precoding scheme;

FIG. 3 shows a typical timeline of CSI measurement and feedback in 3GPP 5G-NR;

FIG. 4 is a block diagram illustrating CSI encoding and decoding using for example, AI/ML models, although the invention is not restricted to AI/ML models;

FIG. 5 illustrates a flowchart of a method performed by a wireless device according to some embodiments

FIG. 6 illustrates a flowchart of a method performed by a wireless device according to some embodiments

FIG. 7 illustrates a flowchart of a method performed by a wireless device according to some embodiments

FIG. 8 is a block diagram depicting a wireless device (user equipment) according to some embodiments herein.

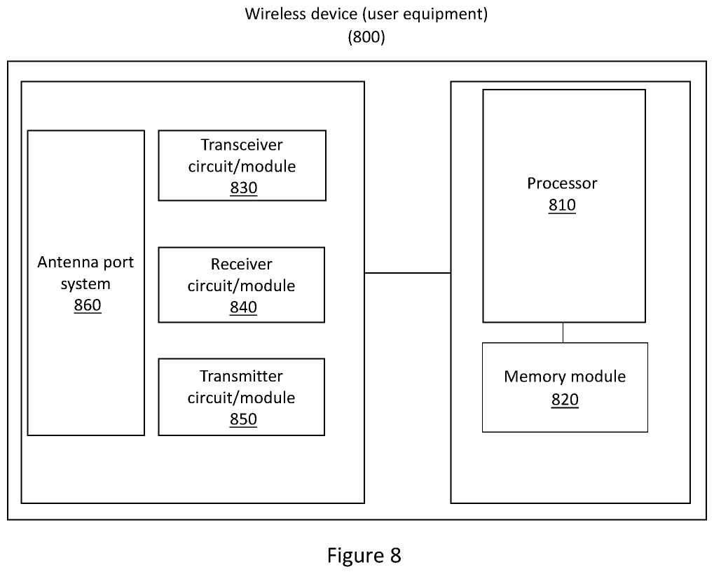

FIG. 9 illustrates a flowchart of a method performed by a network node according to some embodiments

FIG. 10 illustrates a flowchart of a method performed by a network node according to some embodiments

FIG. 11 illustrates a flowchart of a method performed by a network node according to some embodiments

FIG. 12 is a block diagram depicting a network node according to some embodiments herein.

### DETAILED DESCRIPTION

In the following, a detailed description of the exemplary embodiments is described in conjunction with the drawings, in several scenarios to enable easier understanding of the solution(s) described herein.

In a wireless communications network system employing time division duplexing, TDD, due to channel reciprocity, the CSI is available at the base station (gNB). However, when employing frequency division duplexing, FDD, due to the absence of channel reciprocity, the channel is estimated at the UE and the estimate is fed back to the gNB.

The parameters of transmission for the downlink (DL) by a network node to a user equipment (wireless device) can be updated by a channel state information (CSI) feedback from the user equipment. The network configures the wireless device with the parameters to be reported in a CSI feedback/CSI reporting occasion by the wireless device. The reference signal (RS) resource(s) to be measured by the wireless device for the CSI feedback or CSI report are provided to the wireless device by the network node or another communication entity or another wireless device. The CSI feedback is transmitted by the wireless device based on the measurements from one or more RSs such as CRSs, synchronization signal block(s) (SSB(s)) or channel state information reference signal (CSI-RS) resource(s). Upon reception and subsequent measurement of the DL RS(s), the wireless device typically computes an estimate of the channel information between a network node and itself, in addition to the interference and/or noise information on certain occasions based on network configuration and/or wireless device implementation. Based on the above estimate(s) of the channel, interference and/or noise, the wireless device computes and transmits one or more of the following parameters suitable for the transmission of a physical downlink channel in the CSI feedback/report to the network:
CSI-RS Resource Index/Indicator (CRI) or SSB Resource Index/Indicator (SSBRI): The wireless device may report one or more indices that indicate the channel measurement resource(s) (CSI-RS resource(s) and/or SSB(s)) with which one or more of the other parameters in the CSI feedback are associated. The network may configure one or more resources that the wireless device may measure. From the measurements of those resource(s), the wireless device may choose to associate one or more of those resources for PDSCH transmission. Said resource(s) is/are indicated via CRI(s)/SSBRI(s).
Rank Index/Indicator (RI): This parameter denotes the rank of transmission (number of spatial layers of transmission). It is conditioned on a CRI or SSBRI. This means that the rank is computed from the measurements of the resource or is computed for a DL transmission associated with the resource denoted by the CRI/SSBRI.
Precoder Matrix Index/Indicator (PMI): The PMI provides information regarding the spatial precoding to be used (the mapping from the spatial layers for transmission for the PDSCH to a set of antenna port(s)) conditioned at least on a CRI/SSBRI and a corresponding RI. The spatial precoding information contained in the PMI may correspond to subband and/or wideband resolution in frequency, i.e., the information may pertain to the entire CSI reporting band and/or a subset of a CSI reporting band. The network may configure a codebook or precoding type for the computation of the precoding information. This is used in determining the format, size and parameters in the reported precoding information.
Channel Quality Index/Indicator (CQI): The wireless device reports one or more value(s) of CQI for the transmission of one or more transport blocks/codewords conditioned on a spatial precoder (i.e., the PMI or the precoder constructed using the PMI) and/or a RI. The CQI values typically denote modulation and coding schemes (MCS) that could be used for the transmission of a transport block/codeword. A CQI is determined based on the assumption/understanding that a transport block/codeword of PDSCH with the MCS denoted by the CQI would have a block error rate of at most 8, where β is either a value known apriori to the wireless device or is provided by the network. In some examples, when there is no PMI computed by the wireless device, the CQI is conditioned on the RI, but not the PMI. In some other examples, the CQI may be computed conditioned directly on the reference signal measurements without any dependence or conditioning on a PMI or RI (for e.g., when there is no RI or PMI reported). The CQI can be wideband or subband based, i.e., the CQI can be reported for an entire CSI reporting band or for multiple subsets of bands in the CSI reporting band.
Layer Index/Indicator (LI): The LI indicates which column of the precoder matrix of the reported PMI corresponds to the strongest layer of the codeword corresponding to the largest reported wideband CQI.

The CSI feedback/report provided by the wireless device comprising one or more of the above parameters is used for the scheduling of physical downlink channel(s) (e.g., the PDSCH or the PDCCH).

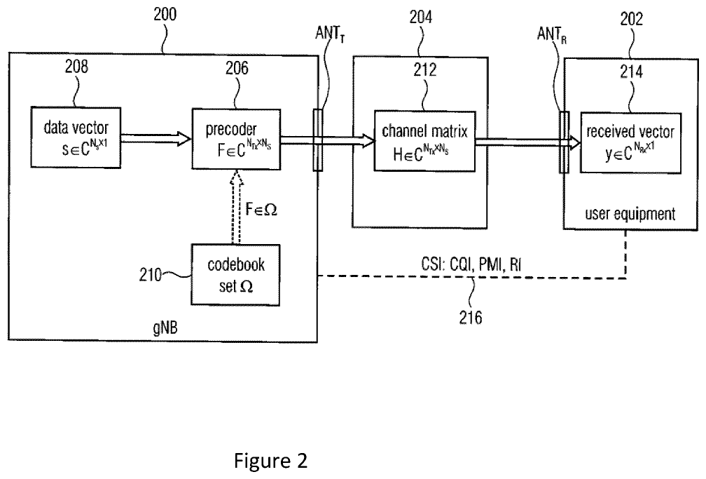

FIG. 2 shows a block-based model of a Multiple Input Multiple Output (MIMO) DL transmission using a codebook-based-precoding method. The base station 200, gNB, the user equipment, UE, 202 and the channel 204, like a radio channel for a wireless data communication between the base station 200 and the user equipment 202. The base station includes an antenna array ANTT having a plurality of antennas or antenna elements, and a precoder 206 receiving a data vector 208 and a precoder matrix F from a codebook 210. The channel 204 may be described by the channel tensor/matrix 212. The user equipment 202 receives the data vector 214 via an antenna or an antenna array ANTR having a plurality of antennas or antenna elements. A feedback channel 216 between the user equipment 202 and the base station 200 is provided for transmitting feedback information. The previous releases of 3GPP up to Release 15 support the use of several downlink reference symbols (such as CSI-RS) for CSI estimation at the UE.

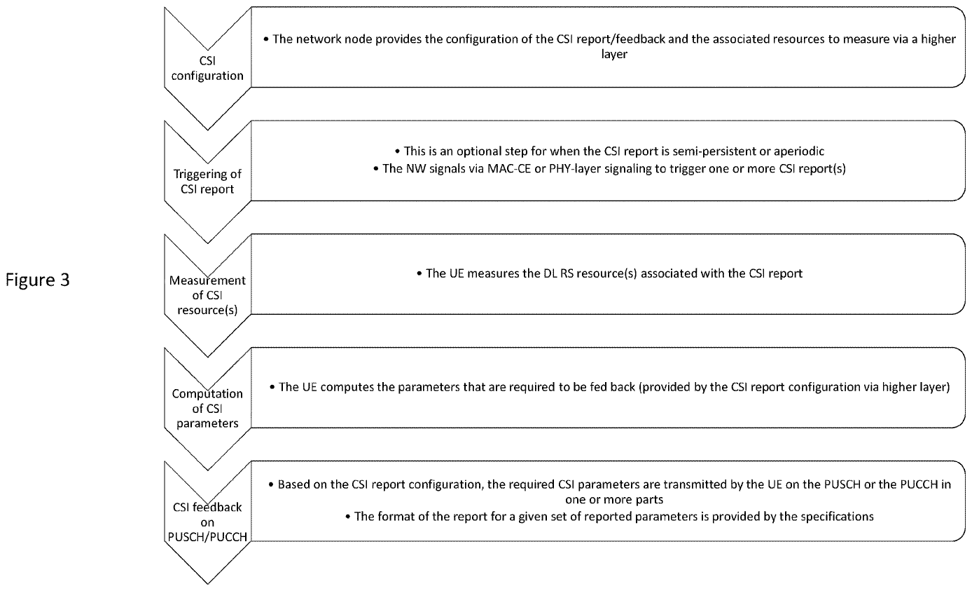

In general, the CSI report configuration provided to a wireless device by a network node comprises (indicates the wireless device to report) one or more of the parameters described above. The CSI report may be transmitted on the Physical Uplink Shared Channel (PUSCH) or the Physical Uplink Control Channel (PUCCH) in one or more parts. An illustration of the typical CSI measurement and reporting timeline in 3GPP 5G New Radio standards is provided in FIG. 3.

In FDD systems (up to Rel. 15), the estimated channel at the UE is reported to the gNB implicitly where the CSI report transmitted by the UE over the feedback channel includes one or more of the following: the rank indicator (RI), the precoding matrix indicator (PMI) and the channel quality indicator (CQI) (and the CRI from Rel. 13), allowing the gNB to decide the spatial precoding, and the modulation order and coding scheme (MCS) of the symbols to be transmitted. The PMI and the RI are used to determine the spatial precoding from a predefined set of matrices Q also referred to as codebook. The codebook, e.g., in accordance with LTE, may be a look-up table with matrices in each entry of the table, and the PMI and RI from the UE decide from which row and column of the table the precoder matrix to be used is obtained. The precoders and codebooks are designed up to Rel. 15 for gNBs equipped with one-dimensional Uniform Linear Arrays (ULAs) having N₁ dual-polarized antennas (in total Nₜ=2N₁ antennas), or with two-dimensional Uniform Planar Arrays (UPAs) having dual-polarized antennas at N₁N₂ positions (in total Nₜ=2N₁N₂ antennas). The ULA allows controlling the radio wave in the horizontal (azimuth) direction only, so that azimuth-only beamforming at the gNB is possible, whereas the UPA supports transmit beamforming on both vertical (elevation) and horizontal (azimuth) directions, which is also referred to as full-dimension (FD) MIMO. The codebook, e.g., in the case of massive antenna arrays such as FD-MIMO, may be a set of beamforming weights that forms spatially separated electromagnetic transmit/receive beams using the array response vectors of the array. The beamforming weights (also referred to as the array steering vectors) of the array are amplitude gains and phase adjustments that are applied to the signal fed to the antennas (or the signal received from the antennas) to transmit (or obtain) a radiation towards (or from) a particular direction. The components of the precoder matrix are obtained from the codebook, and the PMI and the RI are used to read the codebook and obtain the precoder. The array steering vectors may be described by the columns of a 2 Dimensional Discrete Fourier Transform (DFT) matrix when ULAs or UPAs are used for signal transmission.

The precoder matrices used in the Type-I, Type-I multi-panel and Type-II CSI reporting schemes in 3GPP New Radio Rel. 15 are defined in the frequency-domain and have a dual-stage structure (i.e., two components codebook): F(s)=F₁F₂(s), s=0 . . . , S−1, where S denotes the number of subbands. The first component or the so-called first stage precoder, F₁, is used to select a number of beam vectors from a Discrete Fourier Transform-based (DFT-based) matrix, which is also called the spatial codebook. Moreover, the first stage precoder, F₁, corresponds to a wide-band matrix, independent of the subband index s, and contains L spatial beamforming vectors (the so-called spatial beams) bᵢ∈ [symbol] ^{N}^{₁}^{N}^{₂}^{×1}, l=0, . . . , L−1 selected from a DFT-based codebook matrix for the two polarizations of the antenna array,

$${F}_{1} = [ \begin{matrix}{b}_{0} , … , {b}_{L - 1} & 0 … 0 \\ 0 … 0 & {b}_{0} , … , {b}_{L - 1}\end{matrix} ] .$$

For the type-I codebook, L=1 such that F₁ is simply given by

$${F}_{1} = [ \begin{matrix}{b}_{0} & 0 \\ 0 & {b}_{0}\end{matrix} ] .$$

The spatial codebook comprises an oversample DFT matrix of dimension N₁N₂×N₁O₁N₂O₂, where O₁ and O₂ denote the oversampling factors with respect to the first and second dimension of the codebook, respectively. The DFT vectors in the codebook are grouped into (q₁, q₂), 0≤q₁≤O₁−1, 0≤q₂≤O₂−1 subgroups, where each subgroup contains N₁N₂ DFT-based vectors, and the parameters q₁ and q₂ are denoted as the rotation oversampling factors, with respect to the first and second dimension of the antenna array, respectively.

The second component or the so-called second stage precoder, F₂(s), is used to combine the selected beam vectors. This means the second stage precoder, F₂(s), corresponds to a selection/combining/co-phasing matrix to select/combine/co-phase the beams defined in F₁ for the s-th configured sub-band. For example, for a rank-1 transmission and Type-I CSI reporting, F₂(s) is given for a dual-polarized antenna array by

$${F}_{2} ( s ) = [ \begin{matrix}1 \\ {e}^{j {δ}_{1}}\end{matrix} ] , {e}^{j {δ}_{1}}$$

is a quantized co-phasing factor (phase adjustment) between the two orthogonal polarizations of the antenna array. Hence, for the Type-I codebook, a single DFT-beam is selected per transmission layer of the precoding such that the transmission is directed for the strongest path component of the radio channel.

For a rank-1 transmission and Type-II CSI reporting, F₂(s) is given for dual-polarized antenna arrays by

$${F}_{2} ( s ) = [ \begin{matrix}{e}^{j {δ}_{0}} {p}_{0} \\ ⋮ \\ {e}^{j {δ}_{2 L ‐ 1}} {p}_{2 L - 1}\end{matrix} ] ,$$

where pᵢ and e^{jδid}, l=0, 2, . . . , 2L−1 are quantized amplitude and phase beam-combining coefficients, respectively. For rank-R transmission, F₂(s) contains R vectors, wherein R denotes the transmission rank, where the entries of each vector are chosen to combine single or multiple beams within each polarization.

The selection of the matrices F₁ and F₂(s) is performed by the UE based on reference signals such as CSI-RS and the knowledge of the channel conditions. The selected matrices are indicated in a CSI report in the form of a RI (the RI denotes the rank of the precoding matrices) and a PMI and are used at the gNB to update the multi-user precoder for the next transmission time interval.

In addition to the Type-I codebook, the Rel. 15 3GPP specification also defines a Type-I multi-panel (multi-antenna array) codebook for the case the gNB is equipped with multiple (co-located) antenna panels or antenna arrays that are possibly un-calibrated. The precoder for this codebook is similar to the Type-I codebook where a single DFT beam is applied per transmission layer of the precoding matrix. To take into account different spacing between the antenna panels and/or possible phase calibrations errors (e.g., due to different local oscillators) between the antenna panels, a per-panel co-phasing factor is applied to each panel. For example, for a rank-1 transmission and a gNB that is equipped with N_{g}=2 antenna panels, the Type-I multi-panel CSI reporting is defined as

$$F ( s ) = [ \begin{matrix}{b}_{0} \\ {e}^{j {δ}_{1}} {b}_{0} \\ {e}^{j {δ}_{2}} {b}_{0} \\ {e}^{j {δ}_{1}} {e}^{j {δ}_{2}} {b}_{0}\end{matrix} ] ,$$

where e^{jδ}^{₁} and e^{jδ}^{₂} are quantized co-phasing factors with e^{jδ}^{₂} being a panel-specific co-phasing factor applied to the second panel.

In the following, the CSI reporting using AI/ML models instead of a discretized representation via codebooks and/or quantized coefficients is discussed. As previously stated, this invention disclosure is not restricted to AI/ML models. For example, any linear or non-linear methods/mapping can be used, e.g., methods wherein at least one or more of the CSI parameters/coefficients may not be based on discrete representation(s). CSI compression or prediction involving singular/eigen-value decomposition and/or Kalman/Wiener-filtering to represent channel or precoder information, which may also use one or more basis sets for said compression or prediction, can provide such CSI.

### CSI Reporting Using Example AI/ML Models

In certain embodiments, a method for wireless communications performed by a wireless device is proposed, the method comprising, providing a channel state information, CSI, report to a network or a communication entity/device or another wireless device, wherein at least a part of the reported CSI comprises information that is encoded using a CSI encoder.

In certain embodiments, a CSI encoder is used at the wireless device to compress and/or encode a channel or precoder information. The output of a CSI encoder can be a bit-stream or information that is processed and/or quantized to obtain a bit-stream. The bit-stream is then included in a CSI report. The output or the processed output of a CSI encoder is called as an encoded CSI.

In certain embodiments, a CSI report comprising an encoded CSI provided by a CSI encoder is transmitted via an uplink channel such as the PUSCH or the PUCCH to a network node.

In certain embodiments, a CSI encoder comprises one or more parameters that are tuned or trained according to one or more datasets. In some examples, the CSI encoder may include an AI/ML model (e.g., neural networks, learning algorithms with one or more parameters, graph-based dimensionality reduction/compression methods, etc.).

In certain embodiments, a CSI encoder may comprise a neural network or a machine-learning based scheme wherein
at least one parameter of at least one layer of said neural network, or
at least one parameter of said machine learning algorithm,
   is tuned or trained using one or more datasets.

In certain embodiments, the wireless device supports CSI measurements and reporting based on a machine-learning or a neural network-based scheme used to compress/encode the CSI measurements and to report them to a network node. The encoded CSI represents a compressed form of the radio channel (e.g., a downlink channel) or a “compressed” precoder information. In case of a neural network CSI scheme, the wireless device, or another entity in the wireless communication network, may train the one or more layers of a neural network associated with the CSI encoder and/or CSI decoder using one or more downlink measurement resources. The wireless device, or the other entity, may generate the coefficients associated with each layer of the neural network. A layer of the neural network is associated with a set of coefficients/weights obtained via the training.

The CSI feedback/report comprising the encoded CSI is received by a network node or another communication device, and decoded using a CSI decoder. In certain aspects, the UE may also comprise a CSI decoder that produces a decoded CSI corresponding to an encoded CSI provided by the CSI encoder.

In certain embodiments, a CSI decoder is used at a network node or any other communication device/entity, to decompress/decode/reconstruct channel or precoder information from an encoded CSI. A CSI decoder takes an encoded CSI or a processed form of an encoded CSI as an input. The output or the processed output of a CSI decoder is called a decoded CSI.

In certain embodiments, a CSI decoder is used at a wireless device to produce a decoded CSI corresponding to an encoded CSI produced by a CSI encoder at said wireless device. The CSI decoder used at the wireless device may decompress/decode/reconstruct a channel or precoder information from an encoded CSI or may produce a decoded CSI corresponding to an encoded CSI using measurements from DL RS(s) that are used to produce the encoded CSI.

In certain embodiments, a CSI decoder comprises one or more parameters that are tuned or trained according to one or more datasets. In some examples, the CSI decoder may include an AI/ML model (e.g., neural networks, learning algorithms with one or more parameters, graph-based dimensionality reduction/compression methods, etc.).

In certain embodiments, a CSI decoder may comprise a neural network or a machine-learning based scheme wherein
at least one parameter of at least one layer of said neural network, or
at least one parameter of said machine learning algorithm,
   is tuned or trained using one or more datasets.

In certain embodiments, a CSI encoder and/or a CSI decoder employed at a wireless device is proprietary to the wireless device.

In certain embodiments, a CSI encoder and/or a CSI decoder employed at a network node is proprietary to the network node.

In certain embodiments, the algorithm/model used by the CSI encoder/decoder employed by the wireless device and/or the network node have been trained using corresponding set(s) of training data.

In certain aspects, the training is performed offline, i.e., at a specific instant in time by a vendor. The training may be performed based on synthetically generated training data or may be performed based on manually collected/measured training data or a combination thereof. The training may be performed by one or two vendors associated to the wireless device and the network, respectively.

In certain aspects, the training is performed online, i.e., the parameters are updated for said algorithm/model by the wireless device and/or network node using data collected from at least the measurements of one or more DL/UL reference signal resources, or a processed version thereof. In certain aspects, the parameter(s) of an algorithm used by CSI encoder/decoder at a wireless device is/are updated using data provided by a network node. In certain aspects the parameter(s) of an algorithm used by CSI encoder/decoder at a network node is/are updated using data provided by a wireless device.

In certain embodiments, the models used by the CSI encoder and CSI decoder are tuned/trained jointly or separately by the respective vendor(s).

In certain embodiments, at least a model used by a CSI encoder(s) and/or CSI decoder(s) employed by the wireless device and/or the network node is/are stored at a remote server, e.g., a specific server provided by the vendor(s). Each AI/ML model used in a CSI encoder/decoder may be associated with a dedicated model identifier. The remote server may provide a plurality of different AI/ML models for deployment at different wireless devices.

In certain embodiments, the wireless device and/or the network node is configured to retrieve
the CSI encoder(s) and/or CSI decoder(s), or
at least an AI/ML model or an algorithm used in CSI encoder(s) and/or CSI decoder(s),
   from the remote server, e.g., based on an identifier. For this purpose, the wireless device and/or the network node may establish a dedicated communication link.

In certain embodiments, the wireless device and/or the network node are pre-provisioned with the AI/ML model(s) to be used. In this case, no retrieval of the AI/ML model(s) from a remote server may be required.

In certain embodiments, the machine learning based schemes used in a CSI encoder or CSI decoder may include or comprise regression-based model(s)/algorithm(s) (e.g., e.g., decision tree regression, nearest-neighbour regression, etc.), graph-based algorithms, or any model or algorithm whose parameter(s) is tuned/trained via one or more data sets.

In certain embodiments, the CSI encoder or CSI decoder may involve one or more pre-processing steps wherein a certain information is processed before provided as an input to the model used by the encoder/decoder.

In certain example, an encoded CSI obtained from a CSI encoder may involve one or more post-processing steps before it is included in a CSI report. For example, along with the encoded CSI, the wireless device may append additional information related to the CSI encoding such as any information regarding a channel or precoding information encoded such as,
a rank indication,
Doppler information, and/or
Delay information.

The CSI encoder is typically employed to perform CSI compression and/or prediction. From the measurements made by the UE from one or more DL RS resources (and possibly other parameters, measurements and/or observations), the UE obtains a channel estimate/precoder information, which is then (with certain pre-processing in some cases) compressed or encoded by a CSI encoder. Using AI/ML models for this purpose is predicted to provide significant performance gains compared to traditional channel and precoder information compression methods.

Again, this invention disclosure is not restricted to AI/ML models. For example, any linear or non-linear methods/mapping can be used, e.g., methods wherein at least one or more of the CSI parameters/coefficients may not be based on discrete representation(s). CSI compression or prediction involving singular/eigen-value decomposition and/or Kalman/Wiener-filtering to represent channel or precoder information, which may also use one or more basis sets for said compression or prediction, can provide such CSI.

In certain embodiments, the wireless device is configured to employ a CSI encoder to determine an encoded CSI or a part of an encoded CSI associated with one or more downlink reference signal resources.

In certain embodiments, the encoded CSI represents or corresponds to a channel or precoder information associated with said DL RS resource(s). The encoded CSI is obtained/computed using the measurement(s) of said downlink reference signal resources.

In certain embodiments, the wireless device uses/comprises, in a CSI encoder, a part of a two-sided neural network such as an auto-encoder. In some examples, the encoder part of the auto-encoder is used in a CSI encoder.

In certain embodiments, the encoded CSI obtained from a CSI encoder at a wireless device, may represent or correspond to at least one of the following:
a channel information or at least a part of a channel information, or
a precoder information or at least a part of a precoder information.

In certain embodiments, the channel or precoder information that an encoded CSI represents or corresponds to is computed or obtained using the measurements of one or more said downlink reference signal resources.

In certain embodiments, the channel or precoder information that an encoded CSI represents or corresponds to is computed or obtained using the measurements from a burst of one or more said downlink reference signal resources.

In accordance with embodiments, the encoded CSI obtained from a CSI encoder at a wireless device, may represent or correspond to at least one of the following:
a channel information or at least a part of a channel information which is computed using the measurements of one or more said downlink reference signal resources,
a precoder information or at least a part of a precoder information which is computed using the measurements of one or more said downlink reference signal resources,
a precoder information or at least a part of a precoder information which is computed using the measurements from a burst of one or more said downlink reference signal resources.

In certain embodiments, the channel information may be at least one of the following:
channel coefficients and/or information regarding the channel coefficients associated with at least one of the said DL RS resources, in at least one subband within a CSI reporting band.
vector(s)/matrix (matrices) obtained using an eigen-/singular-value decomposition and/or information regarding same computed using a channel information associated with at least one of the said DL RS resources, in at least one subband within a CSI reporting band.

In certain embodiments, an encoded CSI obtained from a CSI encoder in one instance of processing by the CSI encoder may represent or correspond to a channel or precoder information or a “compressed” channel or precoder information associated with one or more layers.

In certain embodiments, the precoder information or compressed precoder information may include one or more of the following:
coefficient(s) of one or more precoder matrices/vectors,
information regarding one or more precoder matrices/vectors wherein the information comprises a linear combination using one or more vectors selected from one or more basis sets, e.g., a first basis that may correspond to the spatial domain (defined across antenna ports), and/or a second basis that may correspond to a delay domain (defined across a number of subbands), and/or a third basis set that may correspond to a Doppler domain (defined across a number of slots), etc,
coefficient(s) of one or more precoder matrices/vectors computed using at least a singular/eigenvalue decomposition of a channel information in spatial, delay and/or Doppler domain,
indicator(s)/index (indices)/identifier(s) to denote/represent one or more precoder matrices or vectors, which may be performed via a codebook.

In certain embodiments, the channel or precoder information comprises complex valued coefficients.

In certain embodiments, the coefficients contained in said channel or precoder information are quantized.

In certain embodiments, the channel or precoder information is provided as an input to a CSI encoder to provide an encoded CSI. In some examples, the input may be quantized (or involve further pre-processing) before provided to the CSI encoder as input. In certain embodiments, the decoded CSI may represent or correspond to a channel or precoder information that is represented by the encoded CSI it processes.

In some examples, a given decoded CSI has a one-to-one correspondence with an encoded CSI. This means that a given stream of bits representing an encoded CSI has a unique decoded CSI.

In certain embodiments, the wireless device is configured to employ at least one CSI decoder to obtain/determine a decoded CSI.

In certain embodiments, a CSI decoder comprises a part of a two-sided neural network such as an auto-encoder. In some examples, the decoder part of the auto-encoder is used in a CSI decoding. The encoder part of the auto encoder is used, in some examples, at the wireless device providing the corresponding encoded CSI.

In certain embodiments, the decoded CSI can be one or more matrices/vectors used for spatial precoding or one or more indices/indicators/parameters representing one or more matrices used for spatial precoding, wherein each precoding matrix or precoding matrix index/indicator/parameter is associated with at least one subband within a CSI reporting band.

In certain embodiments, the decoded CSI can be one or more matrices/vectors that correspond to a channel information or one or more indices/indicators/parameters representing one or more matrices corresponding to a channel information, wherein each matrix/vector or index/indicator/parameter is associated with at least one subband within a CSI reporting band.

In certain embodiments, the wireless device is configured, e.g., from a network node, with the number of subbands within a CSI reporting band to determine various parameters related to an encoded and/or decoded CSI.

In certain embodiments, the wireless device calculates an encoded CSI representing a channel/precoder vector or matrix Cᵢ or multiple channel/precoder vectors/matrices {Cᵢ_{₁}, . . . , Cᵢ_{ₙ}}, n>1 corresponding to a number of subbands within a CSI reporting band using a CSI encoder. The encoded CSI may be represented by a stream of bits Bᵢ. The encoded CSI may be calculated from measurements of one or more DL RS resource(s). The encoded CSI is included in a CSI report and transmitted to a network node, e.g., gNB, or another communication device.

The measurements on the DL RS resource(s) are performed by the wireless device in slot n or slots [n₁, n₂, . . . ]. In some examples, the encoded CSI calculated by the wireless derive represents a channel information or precoder information for one or more future slot(s), i.e., n+k, or n₁+k, n₂+k, . . . , wherein k>0. This means the CSI encoder (which may comprise an AI/ML algorithm/model) performs CSI prediction.

One or more CSI decoders at a network node or a communication entity or another wireless device that receives the CSI report may process the stream of bits Bᵢ rom the encoded CSI to obtain a decoded CSI Dᵢ or {Dᵢ_{₁}, . . . , Dᵢ_{ₙ}}. The decoded CSI Dᵢ or {Dᵢ_{₁}, . . . , Dᵢ_{ₙ}} may represent a channel/precoder matrix (matrices) or vector(s) that may or may not be identical to the channel/precoder (matrices) or vector(s) Cᵢ or {Cᵢ_{₁}, . . . , Cᵢ_{ₙ}}. The CSI decoder(s) at the network node is/are typically attempting to reconstruct the channel/precoder matrix (matrices) or vector(s) Cᵢ or {Cᵢ_{₁}, . . . , Cᵢ_{ₙ}} from the bit stream Bᵢ with a certain level of confidence/accuracy. The decoder(s) may be based on AI/ML model(s) (for e.g., the AI/ML model used in CSI decoding may be a neural network or a part of a neural network) as well.

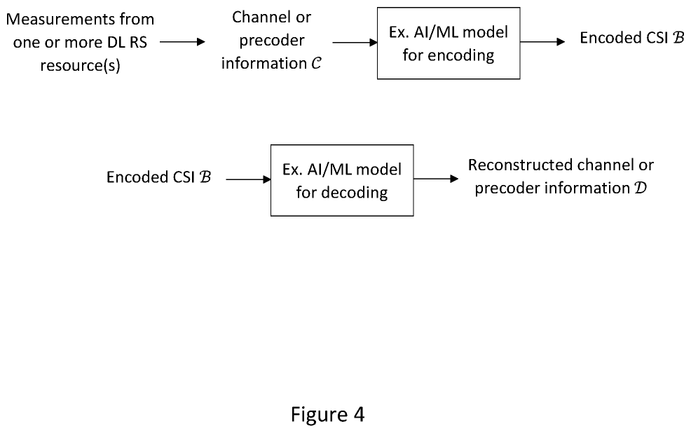

An illustration of a AI/ML model based CSI encoding and decoding are provided in FIG. 4.

Again, this invention disclosure is not restricted to AI/ML models. For example, any linear or non-linear methods/mapping can be used, e.g., methods wherein at least one or more of the CSI parameters/coefficients may not be based on discrete representation(s). CSI compression or prediction involving singular/eigen-value decomposition and/or Kalman/Wiener-filtering to represent channel or precoder information, which may also use one or more basis sets for said compression or prediction, can provide such CSI.

In certain embodiments, the wireless device calculates a CQI value using at least the encoded CSI and includes the CQI value in the CSI report.

In certain exemplary embodiments, a method for wireless communications performed by a wireless device is proposed, the method comprising,
determining an encoded channel state information, CSI, using at least measurements from one or more DL RS resource(s),
determining at least one CQI value using the information encoded by said AI/ML model, and
   transmitting to a network node or another wireless device, a CSI report comprising said at least one CQI value.

In some examples, the CSI report provided by the wireless device may comprise a wideband CQI or one or more CQI(s) corresponding to one or more subband(s) of the CSI reporting band that is computed based on the channel/precoder information Cᵢ or {Cᵢ_{₁}, . . . , Cᵢ_{ₙ}} represented by the encoded CSI as described above.

With AI/ML-based encoding and decoding of the CSI, the decoded channel/precoding matrix/matrices at the network node may not be identical to the ones encoded into the CSI report by the wireless device. Hence, the aforementioned conditioning of the CQI value(s) on the encoded CSI may lead to a mismatch when scheduling precoded downlink transmissions by the network node. This may lead to a performance degradation. This issue is addressed in the following for various scenarios of wireless device capability and network-wireless device compatibility.

Instead of AI/ML models, any linear or non-linear methods/mapping can be used tot he embodiments herein, e.g., methods wherein at least one or more of the CSI parameters/coefficients may not be based on discrete representation(s). CSI compression or prediction involving singular/eigen-value decomposition and/or Kalman/Wiener-filtering to represent channel or precoder information, which may also use one or more basis sets for said compression or prediction, can provide such CSI.

### Decoded CSI for CQI Determination

The accuracy of the reported CQI information reflecting the BLER guaranteed by a DL transmission is crucial in making scheduling decisions at the network node and in providing performance guarantees in the DL. To ensure accuracy of CQI information with AI/ML based CSI encoding, the conditioning of reported CQI value(s) with a decoded CSI rather than the encoded CSI can be performed.

In certain exemplary embodiments, a method for wireless communications performed by a wireless device is proposed, the method comprising
receiving, from a network node or another wireless device, a channel state information, CSI, report configuration,
performing measurement(s) of one or more downlink reference signal resource(s) provided by the CSI report configuration,
determining an encoded channel state information, CSI, using at least said measurement(s) and a first AI/ML model or a part of a first AI/ML model,
determining a decoded CSI corresponding to said encoded CSI using at least a second AI/ML model or another part of said first AI/ML model used for the encoding,
determining at least one CQI value calculated using said decoded CSI,
   and transmitting to a network node or another wireless device, a CSI report comprising said at least one CQI value.

In certain embodiments, the AI/ML model used to determine an encoded CSI is a neural network.

In certain embodiments, the AI/ML model used to determine a decoded CSI is a neural network.

Instead of AI/ML models, any linear or non-linear methods/mapping can be used to the embodiments herein, e.g., methods wherein at least one or more of the CSI parameters/coefficients may not be based on discrete representation(s). CSI compression or prediction involving singular/eigen-value decomposition and/or Kalman/Wiener-filtering to represent channel or precoder information, which may also use one or more basis sets for said compression or prediction, can provide such CSI.

In certain embodiments, the CSI report comprises said encoded CSI.

The one or more DL RS resource(s) measured by the wireless device may comprise a certain resource mapping/allocation in an NR radio frame and/or bandwidth. Each DL RS resource is associated with one or more antenna ports. The DL RS resource(s) measured by the wireless device may be at least one of the following:
Channel State Information Reference Signal (CSI-RS) resource(s) of non-zero power, i.e., Non-Zero-Power CSI-RS (NZP-CSI-RS) resource(s),
Synchronization Signal Block(s) (SSB(s)),
CSI-RS resource(s) of zero power, i.e., Zero-Power CSI-RS (ZP-CSI-RS) resource(s),
CSI-Interference Management (CSI-IM) resource(s).

When the DL RS resource(s) is/are CSI-RS resource(s), each CSI-RS resource is associated with multiple antenna or CSI-RS ports.

In certain embodiments, the wireless device may measure the one or more DL-RS resources across one or more slots and/or subframes and/or frames for the determination of the encoded CSI.

In certain embodiments, the measurements of a DL RS resource used in the determination of an encoded CSI using as an example an AI/ML model may be obtained from one or more slots and/or subframes and/or frames on which said DL RS resource is received and/or measured.

In certain embodiments, one or more measurements used in the determination of an encoded CSI using an AI/ML model may be obtained from a ‘burst’ of a DL RS resource or a set of DL RS resources that are received or measured by the wireless device across one or more slots and/or subframes and/or frames. In one example, a burst may mean the repetition of a DL RS resource across one or more slots/subframes/frames. In another example, a burst may mean the transmission of a series of resources in succession across one or more slots/subframes/frames (e.g., a SSB burst). In some configurations of such a burst, at least one subset of resources may occupy identical time-domain resources (e.g., a CSI-RS burst using a set of CSI-RS resources).

In certain embodiments, the wireless device reports information related to the CSI decoder used to calculate the CQI value(s) to the network node or another wireless device.

In certain embodiments, the wireless device employs or supports one or more CSI decoders. The CSI decoder(s) may be identical to or different from the CSI decoder(s) at the network node or the communication entity decoding the encoded CSI in the CSI report. In one example, the CSI decoder(s) or information about the decoder(s) used by the wireless device to calculate the CQI value is configured to the wireless device from the network node or another communication entity or another wireless device.

The decoders employed at the wireless device and the network or communication entity or another wireless device processing the encoded CSI in the CSI report may be different in the following circumstances:
the decoding neural network at the network-side is developed by a vendor different from that of the wireless device vendor and the format of the decoder delivered is incompatible with the wireless device's chipset or implementation required of the decoder neural network,
the decoding neural network's complexity or required storage memory is too high for the wireless device to not deploy it for CQI computation,
the decoding neural network at the network-side is updated frequently and it costs high overhead to inform the wireless device about the updates.

In certain embodiments, the wireless device employs or supports one or more CSI decoders, wherein each decoder is associated with an identifier.

In certain embodiments, the information transmitted by the wireless device regarding the CSI decoder comprises at least one of the following:
an identifier of the CSI decoder used for the computation of at least one CQI value in a CSI report,
at least one index or at least one value that is associated with the performance of the CSI decoder in the reconstruction/decoding of the encoded CSI,
any information relating to the structure or processing of the decoder, for e.g., pre-processing or post-processing steps used before or after the processing using an AI/ML model, at least one of the following parameters used by a neural network in the decoder: the number of layers, the types of one or more layers, the dimensions of the inputs/outputs across one or more layers and/or the parameters of at least one layer, etc.

In certain embodiments, the wireless device selects the CSI decoder to be used for the CQI calculation from a plurality of decoders. The one or more CSI decoders or information about the CSI decoders may be provided to the wireless device by the network node or another communication entity or wireless device, or they are defined in the NR specifications and known by the wireless device.

In certain embodiments, the wireless device reports information related to a CSI decoder used for calculating a CQI value to the network node, e.g., as a part of a CSI report.

In certain embodiments, a network node or another communication entity or wireless device indicates to the wireless device, which decoder shall be used for calculating a CQI value.

In accordance with an embodiment, the wireless device employs or supports one or more CSI encoders.

In accordance with an embodiment, the wireless device is configured to receive an indication or configuration from a network node that indicates which CSI encoder shall be used to compute a CQI value.

In accordance with an embodiment, an AI/ML model used for CSI decoding is provided to the wireless device as ancillary/accompanying/assistance information along with a CSI encoder by a network node or another communication entity, or is available/known a priori at the wireless device.

In certain embodiments, the decoded CSI may be one or more channel/precoding vector(s) or matrix/matrices, or information associated with it/them that is/are associated with at least one subband within a CSI reporting band. In some examples, a given decoded CSI information has a one-to-one correspondence with an encoded CSI, the stream of bits obtained after a CSI is encoded in a wireless device, which may be performed at least by a neural network. This means that a given stream of bits representing an encoded CSI has a unique decoded CSI.

In certain embodiments, a ‘decoder’ or a ‘CSI decoder’ used to obtain/determine a decoded CSI may comprise at least one of the following:
an AI/ML model that processes the stream of bits representing an encoded CSI or an information obtained from the stream of bits representing an encoded CSI and produces at least a corresponding decoded CSI,
an AI/ML model that processes at least an information obtained/computed using the measurement(s) of one or more DL RS(s) and produces as an output, a decoded CSI wherein the decoded CSI has a one-to-one correspondence to an encoded CSI that would be/is produced by an encoding CSI network at the wireless device by processing the aforementioned information obtained/computed using the measurement(s) of one or more DL RS(s).

In certain embodiments, the wireless device is configured to employ at least one ‘decoder’ or ‘CSI decoder’ to obtain/determine a decoded CSI.

In certain embodiments, the wireless device is configured to transmit a CSI report to a network node or any other entity. The receiver of the CSI report may comprise a decoder that processes the encoded channel state information in the CSI report to obtain or ‘reconstruct’ at least the underlying channel state information.

In certain embodiments, the AI/ML model used to determine a decoded CSI is a neural network.

In certain embodiments, the wireless device uses/comprises, for CSI decoding, a part of a two-sided neural network such as an auto-encoder. In some examples, the decoder part of the auto-encoder is used for CSI decoding. The encoder part of the auto encoder is used, in some examples, at the wireless device providing the encoded CSI.

In certain embodiments, the decoded CSI can be one or more matrices used for spatial precoding or one or more indices/indicators/parameters representing one or more matrices used for spatial precoding, wherein each precoding matrix or precoding matrix index/indicator/parameter is associated with at least one subband within a CSI reporting band.

In certain embodiments, the wireless device is configured, e.g., from a network node, with the number of subbands within a CSI reporting band to determine various parameters related to an encoded and/or decoded CSI.

In certain embodiments, the information related to at least an AI/ML model used in CSI encoding and/or an AI/ML model used in CSI decoding is provided to the wireless device by a network node or any other communication entity, or is available/known a priori at the wireless device.

In accordance with an embodiment, the wireless device employs or supports one or more CSI encoders.

In accordance with an embodiment, the wireless device is configured to receive an indication or configuration from a network node that indicates which CSI encoder shall be used to compute a CQI value.

In accordance with an exemplary embodiment, an AI/ML model used for CSI decoding is provided to the wireless device as ancillary/accompanying/assistance information along with a CSI encoder by a network node or another communication entity, or is available/known a priori at the wireless device.

### Reporting Multiple CQI Values

In certain embodiments, a method for wireless communications performed by a wireless device is proposed, the method comprising:
receiving, from a network node, a channel state information, CSI, report configuration,
performing measurement(s) of one or more downlink, DL, reference signal resource(s) provided by the CSI report configuration,
determining an encoded channel state information, CSI, using at least the measurement(s) of the one or more DL RS(s),
determining a first CQI value using the encoded CSI,
determining a reference CSI using the measurement(s) of the one or more DL RS(s),
determining a second CQI value using the reference CSI,
reporting or transmitting to a network node, one or more CSI reports, comprising information related to the first CQI value and the second CQI value.

In certain embodiments, a method for wireless communications performed by a wireless device is proposed, the method comprising:
receiving, from a network node, a channel state information, CSI, report configuration,
performing measurement(s) of one or more downlink, DL, reference signal resource(s) provided by the CSI report configuration,
determining an encoded channel state information, CSI, using at least the measurement(s) of the one or more DL RS(s),
determining a first CQI value using the encoded CSI,
determining a reference CSI using the measurement(s) of the one or more DL RS(s),
determining a second CQI value using the reference CSI,
reporting or transmitting to a network node, a CSI report comprising information related to the first CQI value and the second CQI value.

In certain embodiments, the CSI report comprises said encoded CSI.

In certain embodiments, the CSI report comprises said encoded CSI and reference CSI.

In certain embodiments, the second CQI value, or information related to the second CQI value, is reported in a separate CSI report or CSI reporting instance.

In certain embodiments, the first CQI value is reported in a first CSI report or CSI reporting instance, and the second CQI value, or information related to the second CQI value, is reported in a separate second CSI report or CSI reporting instance.

In certain embodiments, the reference CSI indicates a reference precoding information, wherein the reference precoding information uses a linear combination of basis vectors selected from a basis set, and a set of co-phasing coefficients to form one or more precoding matrices associated with a number of antenna ports and/or subbands in a CSI reporting band.

In certain embodiments, the reference CSI indicates a reference precoding information, wherein the reference precoding information uses a linear combination of basis vectors selected from a first basis set and a second basis set, and a set of linear combination coefficients to form one or more precoding matrices associated with a number of antenna ports and/or subbands in a CSI reporting band.

In certain embodiments, the reference CSI indicates a reference precoding information, wherein the reference precoding information uses a linear combination of basis vectors selected from a first basis set, a second basis set and a third basis set, and a set of linear combination coefficients to form one or more precoding matrices associated with a number of antenna ports and/or subbands in a CSI reporting band and/or slots.

In certain embodiments, the basis vectors of the first basis set are spatial domain basis vectors defined across a number of antenna or CSI-RS ports, wherein the antenna or CSI-RS ports are configured from a network node to the wireless device. The basis vectors of the second basis set are delay domain basis vectors defined across N₃ subbands, wherein the number N₃ is configured from a network node to the wireless device. In some examples, the basis vectors of the first and second basis sets are discrete Fourier transform, DFT, based vectors.

In certain embodiments, the basis vectors of the third basis set are Doppler domain basis vectors defined across a number of slots. The basis vectors of the third basis set are Doppler domain basis vectors defined across N₄ slots. The number N₄ may be configured from a network node to the wireless device. In some examples, the basis vectors of the third basis sets are discrete Fourier transform, DFT, based vectors.

The CSI report can comprise a first CQI value and a second CQI value. Note that the first CQI value can be identical or not to the second CQI value. In some examples, the encoded CSI reported to the network node may indicate a (“compressed”) precoding matrix that is either obtained after decoding the encoded CSI, or obtained using at least the measurements of one or more DL RS resource(s) (based on which the encoded CSI is determined). The reference CSI may indicate a reference precoding matrix. The wireless device determines encoded CSI and the reference CSI (both precoding matrices) corresponding to both the CQIs by measurements on the same DL RS(s).

For specific radio channel environments or scenarios of the AI/ML models deployed at the wireless device and the network receiving the CSI report, the precoder obtained from the decoded CSI at the network and the reference precoder can be identical or close to identical. This means that the CSI encoding represents or approximates the desired/reference spatial precoding very well and the decoder at the network is able to recover/reconstruct the precoder information from the encoded CSI with reasonable or very good accuracy. In such cases, the first CQI value and the second CQI value are identical.

However, when the coefficients of the precoder matrix and the reference precoder matrix are non-identical or largely different, the two CQI values can be different as well. In such cases, the network node may take into account the first and the second CQI values for its scheduling decisions and/or scheduling optimization. Moreover, when for a number of CSI reports the first and the second CQI values are different, the network node may also indicate to the wireless device to adapt or to update the CSI encoder at the wireless device. As an example, the wireless device could update the parameters of the AI/ML model used for the CSI encoding so that the difference between the two CQI values decreases. This method of CQI reporting is also helpful for the network in gauging the need for updates with its CSI decoder.

In certain embodiments, the information related to the first and/or second CQI value provided in a CSI report is a differential CQI value. For example, the said first CQI value is reported on an ‘absolute/actual/non-differential’ basis, while the information related to the second CQI is a differential CQI value with respect to the first CQI value or vice versa.

In certain embodiments, the wireless device, in response to a signalling from the network node via the PHY-layer or a higher layer (e.g., RRC signalling, MAC-CE message), reports or transmits information related to only one of said two CQI values. In some examples, the UE reports or transmits information related to only the first CQI value. Similarly, in certain aspects, the wireless device, in response to a signalling from the network node via the PHY-layer or a higher layer (e.g., RRC signalling, MAC-CE message), reports or transmits information related to both said CQI values in one or more CSI reports/reporting occasions. This signalling can be used to switch between one or two CQI values, to constantly verify the accuracy of the CSI compression/prediction. Again, instead of AI/ML models, any linear or non-linear methods/mapping can be used to the embodiments herein, e.g., methods wherein at least one or more of the CSI parameters/coefficients may not exemplar on discrete representation(s). CSI compression or prediction involving singular/eigen-value decomposition and/or Kalman/Wiener-filtering to represent channel or precoder information, which may also use one or more basis sets for said compression or prediction, can provide such CSI.

### CQI Correction

As described in the previous subsection, it may not always be possible to have the same decoder implementation at the wireless device as the receiver that is decoding the CSI. In addition, it may not be possible for the wireless device to employ/deploy any decoding AI/ML model due to limited wireless device capabilities or power-saving manoeuvres carried out at the wireless device. Therefore, the CQI correction may have to be performed in some other way.

In certain embodiments, a method for wireless communications by a wireless device is proposed, the method comprising:
receiving, from a network node, a channel state information, CSI, report configuration,
performing measurement(s) of one or more downlink reference signal resource(s) provided by the CSI report configuration,
determining an encoded channel state information, CSI, using at least the measurement(s) from one or more DL RS(s),
determining at least one channel quality index/index, CQI, value using the value(s) of at least one CQI correction parameter, and
transmitting to the network node or any other communication entity, a CSI report comprising said at least one CQI value.

In certain embodiments, the method comprises:
determining a decoded CSI corresponding to said encoded CSI,
determining at least one channel quality index/index, CQI, value using the value(s) of at least one CQI correction parameter and said decoded CSI, and
transmitting to the network node or any other communication entity, a CSI report comprising said at least one CQI value.

In certain embodiments, the CSI report comprises the said encoded CSI.

In certain embodiments, the wireless device is configured to report an encoded CSI obtained at least using an AI/ML model and a reference CSI, in one or more CSI reports or reporting occasions, wherein the encoded CSI and the reference CSI are obtained/computed based on the measurements on the same downlink reference signal resource(s). In some examples, the reference CSI is a Rel. 15, 16, 17 or 18 enhanced Type-II-like CSI. The decoded CSI represents a close approximation of the reference CSI used for determining the CQI value at the wireless device. In some examples, the network node uses the encoded CSI to calculate a decoded CSI using a neural network at the network node. The difference between the reference CSI and decoded CSI is used by the network node to calculate a CQI correction parameter. In some examples, the CQI correction parameter is signalled to the wireless device.

The value(s) of the CQI correction parameter(s) may be obtained In at least one of the following ways:
a communication entity provides the wireless device with the CQI correction parameter(s) or it provides the wireless device with a signalling that helps the wireless device determine the CQI correction parameter(s),
the CQI correction parameter is known to the wireless device.

In one example, the communication entity can be a network node that provides the value(s) of said parameter(s) or provide(s) at least some information via the physical layer or a higher layer for determining the value(s) of said parameter(s). In another example, the communication entity provides the information to the wireless device “out-of-band”, i.e., if the wireless device is to provide a CSI feedback configured by a 3GPP-based or IEEE-standards-based network, the information is provided by a network or entity outside of the 3GPP-based or IEEE-standards-based network/framework, respectively. In a third example, accompanying information to the neural network that encodes the CSI is provided with or helps the wireless device to determine the value(s) of said parameter(s).

In accordance with embodiments, a CQI correction parameter may be at least one of the following:
a parameter that denotes the accuracy or error in the reconstruction of the CSI by the neural network that decodes the encoded CSI,
a parameter that denotes a ‘confidence measure’ of the CSI obtained from the decoding neural network employed at the entity receiving the CSI report,
a parameter that is employed in an expression for the determination of a precoder matrix or precoder matrices used for the calculation of at least one CQI value.

In accordance with embodiments, the wireless device is configured with at least one CQI correction value, say γ, that is used for ‘correcting’ or ‘tuning’ at least one CQI value reported to the network node. In some examples, the value γ indicates an accuracy of reconstruction at the CSI decoder for the CSI encoder used at the wireless device or it may be an index/indicator that indicates the ‘confidence’ of the CQI value(s) for a channel/precoder information reconstructed by a decoder of the encoded information. Also, γ may indicate the similarity of the decoded CSI at the network-side and the CSI measurements of DL RS resources before encoding at the wireless device.

In certain embodiments, the CQI correction parameter comprises one or more sub-parameters. In one example, the CQI correction parameter is a configuration comprising a set of parameters within the configuration, each comprising one or more values.

In certain embodiments, the wireless device is configured to determine the CQI value using at least one of the following:
the encoded CSI calculated by the wireless device,
a rank value computed at least using the measurement of one or more downlink reference signal resources,
the value(s) of one or more CQI correction parameters.

In certain embodiments, the value γ of a CQI correction parameter may be used directly or indirectly in the computation of the at least one CQI value. In some examples, the computation of the CQI value is conditioned on a precoder matrix F_{final}=F+α·G+C, where
F is the precoder matrix computed from the measurement of the one or more DL RS resources for at least a subband in a CSI reporting band or F is a precoder matrix for one or more layers encoded by a neural network at the wireless device,
G is a real- or complex-valued matrix which is of the same size as F, and
α is a real- or complex-valued correction weight obtained as α=f(γ) where f is a linear or non-linear function of a CQI correction parameter value γ to a correction weight α, and
C is a matrix for further corrections of the precoder matrix for CQI evaluation, which may involve corrections involving any parameter other than the aforementioned CQI correction parameter. In some examples, it may just be a zero matrix or a constant matrix (all of the matrix's entries are identical).

In certain embodiments, the ‘CQI correction matrices’ G and C are known to the wireless device or provided to the wireless device by a network node or any other communication entity.

In certain embodiments, the correcting function f may be known to the wireless device or it may be provided to the wireless device by a network node or any other communication entity.

In a direct usage of the CQI correction parameter value for CQI computation, f is an identity mapping, i.e., α=γ. In an indirect usage of the CQI correction parameter value for CQI computation, f is a non-identity mapping.

In certain embodiments, F_{final}=g(F,γ), where g is a linear or a non-linear mapping function to map the precoder F to F_{final}. The function g can be calculated based on a deterministic model as explained above or can be learned by a well-trained AI/ML model (e.g., a one-sided AI/ML model provided to the wireless device by a vendor) at the wireless device. In other words, the mapping function can be an AI/ML model trained by a vendor and provided to the wireless device along with the encoder or a deterministic function.

In certain embodiments, the wireless device is configured to report to a network node at least one value corresponding to at least one CQI correction parameter used in the computation of at least one CQI value during a CSI reporting occasion.

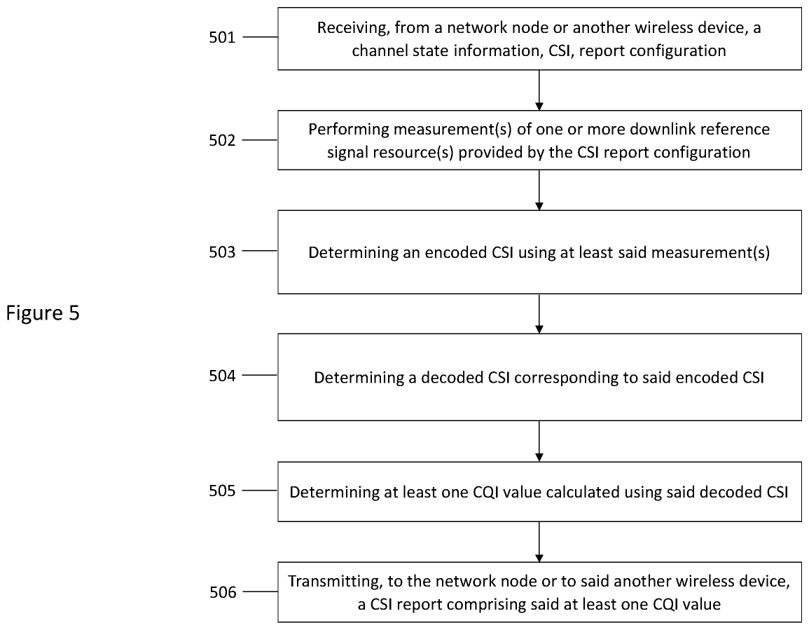

Referring to FIG. 5, there is illustrated a method performed by a wireless device according to some of the previously described embodiments. The method is performed by the wireless device (or UE) for generating and reporting or transmitting a CSI, report, the method comprising:
receiving (501), from a network node or another wireless device, a channel state information, CSI, report configuration,
performing (502) measurement(s) of one or more downlink reference signal resource(s) provided by the CSI report configuration,
determining (503) an encoded channel state information, CSI, using at least said measurement(s),
determining (504) a decoded CSI corresponding to said encoded CSI,
determining (505) at least one CQI value calculated using said decoded CSI,
   and transmitting (506) to a network node or another wireless device, a CSI report comprising said at least one CQI value.

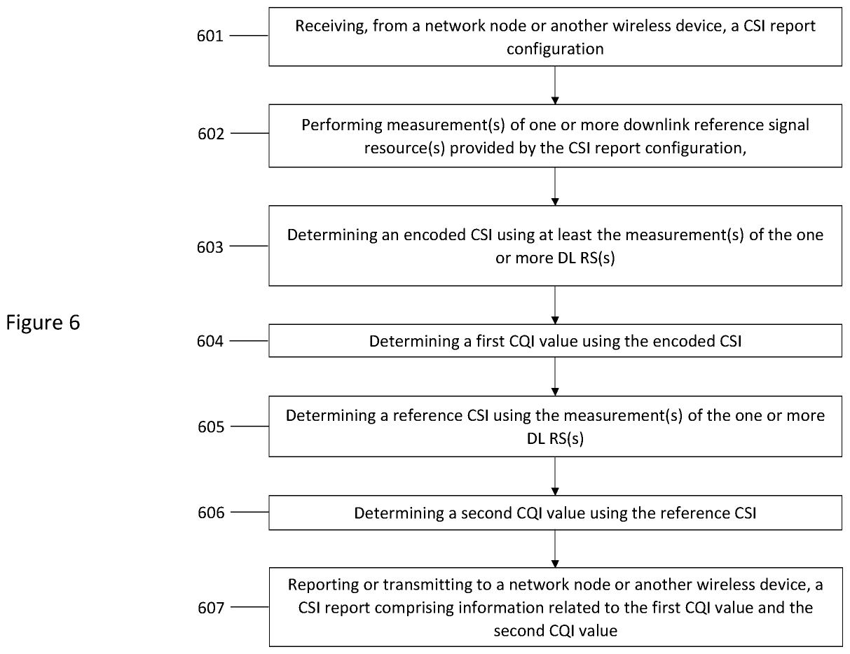

Referring to FIG. 6, there is illustrated another method performed by a wireless device according to some of the previously described embodiments. The method is performed by the wireless device (or UE) for generating and reporting or transmitting a CSI, report, the method comprising:
receiving (601), from a network node or another wireless device, a channel state information, CSI, report configuration,
performing (602) measurement(s) of one or more downlink, DL, reference signal resource(s) provided by the CSI report configuration,
determining (603) an encoded channel state information, CSI, using at least the measurement(s) of the one or more DL RS(s),
determining (604) a first CQI value using the encoded CSI,
determining (605) a reference CSI using the measurement(s) of the one or more DL RS(s),
determining (606) a second CQI value using the reference CSI,
   reporting or transmitting (607) to a network node or another wireless device a CSI report, a CSI report comprising information related to the first CQI value and the second CQI value.

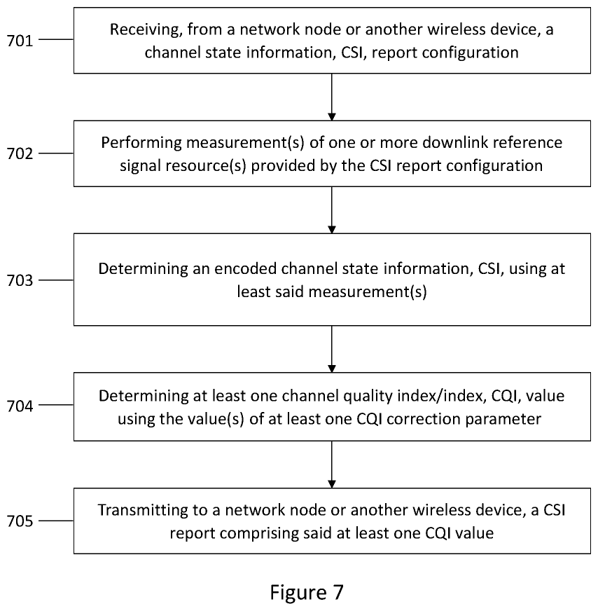

Referring to FIG. 7, there is illustrated another method performed by a wireless device according to some of the previously described embodiments. The method is performed by the wireless device (or UE) for generating and reporting or transmitting a CSI, report, the method comprising:
receiving (701), from a network node or another wireless device, a channel state information, CSI, report configuration,
performing (702) measurement(s) of one or more downlink reference signal resource(s) provided by the CSI report configuration,
determining (703) an encoded channel state information, CSI, using at least the measurement(s) from one or more DL RS(s),
determining (704) at least one channel quality index/index, CQI, value using the value(s) of at least one CQI correction parameter,
   and transmitting (705) to the network node or another wireless device, a CSI report comprising said at least one CQI value.

In order to perform the previously described process or method steps performed by the wireless device or UE, there is also provided a wireless device. FIG. 7 illustrates a simplified block diagram depicting a wireless device or UE 800. The wireless device 800 comprises a processor 810 or processing circuit or a processing module or a processor means 810; a receiver circuit or receiver module 840; a transmitter circuit or transmitter module 850; a memory module 820, a transceiver circuit or transceiver module 830 which may include the transmitter circuit 850 and the receiver circuit 840. The wireless device 800 further comprises an antenna system 860 which includes antenna circuitry for transmitting and receiving signals to/from at least the network node or other wireless device(s). The antenna system employs beamforming as previously described.

The wireless device 800 may belong to any radio access technology including 4G or LTE, LTE-A, 5G, advanced 5G or a combination thereof that support beamforming technology. The wireless device comprising the processor and the memory contains instructions executable by the processor, whereby the wireless device 800 is operative or is configured to perform any one of the embodiments related to the wireless device as previously described.

The processing module/circuit 810 includes a processor, microprocessor, an application specific integrated circuit (ASIC), field programmable gate array (FPGA), or the like, and may be referred to as the “processor.” The processor 810 controls the operation of the wireless device and its components. Memory (circuit or module) 820 includes a random-access memory (RAM), a read only memory (ROM), and/or another type of memory to store data and instructions that may be used by processor 810. In general, it will be understood that the wireless device 800 in one or more embodiments includes fixed or programmed circuitry that is configured to carry out the operations in any of the embodiments disclosed herein.

In at least one such example, the processor 810 includes a microprocessor, microcontroller, DSP, ASIC, FPGA, or other processing circuitry that is configured to execute computer program instructions from a computer program stored in a non-transitory computer-readable medium that is in or is accessible to the processing circuitry. Here, “non-transitory” does not necessarily mean permanent or unchanging storage, and may include storage in working or volatile memory, but the term does connote storage of at least some persistence. The execution of the program instructions specially adapts or configures the processing circuitry to carry out the operations disclosed in this disclosure relating to the wireless device. Further, it will be appreciated that the wireless device 800 may comprise additional components.

The wireless device 800 by means of processor 810 executes instructions contained in the memory 820 whereby the wireless device is operative to perform any one of the previously described embodiments related to the actions performed by the wireless device, some of which are presented in appended claims.

There is also provided a computer program comprising instructions which when executed by the processor 810 of the wireless device cause the processor 810 to carry out the method according to any one of the previously described embodiments.

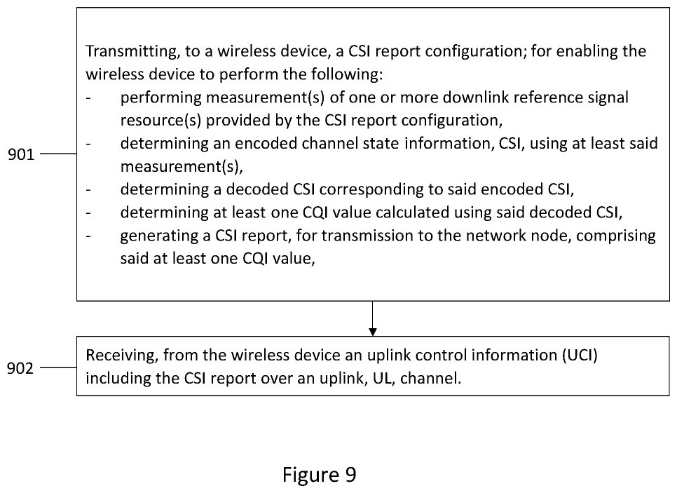

Referring to FIG. 9, there is illustrated a method performed by a network node 1200 according to some of the previously described embodiments. The method performed by the network node 1200 is used for receiving a CSI report from a wireless device 800. FIG. 9 illustrates the main method steps, which comprise:
transmitting (901), to a wireless device, a CSI report configuration; for enabling the wireless device to:
   performing measurement(s) of one or more downlink reference signal resource(s) provided by the CSI report configuration,
   determining an encoded channel state information, CSI, using at least said measurement(s),
   determining a decoded CSI corresponding to said encoded CSI,
   determining at least one CQI value calculated using said decoded CSI, and
   generate a CSI report, for transmission to the network node, comprising said at least one CQI value.
receiving (902), from the wireless device an uplink control information (UCI) including the CSI report over an uplink, UL, channel.

In certain embodiments, the encoded CSI corresponds to or represents a channel/precoder vector or matrix or multiple channel/precoder vectors/matrices corresponding to a number of subbands within a CSI reporting band.

In certain exemplary embodiments, the AI/ML model used to determine an encoded CSI comprises a neural network.

In certain embodiments, the wireless device uses the encoder part of a two-sided neural network such as an auto-encoder for CSI encoding.

In certain embodiments, the CSI decoder determines a channel/precoder matrix (matrices) or vector(s) using the encoded CSI.

In certain exemplary embodiments, the AI/ML model used to determine the decoded CSI comprises a neural network.

In certain embodiments, the CSI decoder uses the decoder part of a two-sided neural network such as an auto-encoder for CSI decoding.

In certain embodiments, the encoder part of said auto-encoder is used by the wireless device to determine the encoded CSI.

In certain embodiments, the wireless device employs or supports one or more CSI decoders and selects a CSI decoder for the CQI calculation from a plurality of decoders.

In certain embodiments, a decoder is associated with an identifier.

In certain embodiments, the wireless device reports information related to the CSI decoder used to calculate the CQI value(s) to the network node or another wireless device.

In certain embodiments, the information regarding the CSI decoder comprises at least one of the following:
an identifier of the CSI decoder used for the computation of at least one CQI value in a CSI report,
at least one index or at least one value that is associated with the performance of the CSI decoder in the reconstruction/decoding of the encoded CSI,
any information relating to the structure or processing of the decoder, for e.g., pre-processing or post-processing steps used before or after the processing using an AI/ML model, at least one of the following parameters used by a neural network in the decoder: the number of layers, the types of one or more layers, the dimensions of the inputs/outputs across one or more layers and/or the parameters of at least one layer, etc.

In certain embodiments, the CSI report comprises said encoded CSI.

In certain embodiments, the reference CSI indicates a reference precoding information comprising a linear combination of basis vectors selected from a first basis set and a second basis set, and a set of linear combination coefficients to form one or more precoding matrices corresponding to at least a subband in a CSI reporting band.

In certain exemplary embodiments, the encoded CSI is obtained at least using an AI/ML model and a reference CSI, in one or more CSI reports or reporting occasions, wherein the encoded CSI and the reference CSI are obtained/based on the measurements on the same downlink reference signal resource(s).

In certain embodiments, the method comprises:
determining a decoded CSI corresponding to said encoded CSI,
determining at least one channel quality index/index, CQI, value using the value(s) of at least one CQI correction parameter and said decoded CSI, and
transmitting to the network node or any other communication entity a CSI report, that comprises said at least one CQI value.

In certain embodiments, the CQI correction parameter is one of the following:
a parameter that denotes the accuracy or error in the reconstruction of the CSI by the neural network that decodes the encoded CSI,
a parameter that denotes a ‘confidence measure’ of the CSI obtained from the decoding neural network employed at the entity receiving the CSI report,
a parameter that is employed in an expression for the determination of a precoder matrix or precoder matrices used for the calculation of at least one CQI value.

In certain embodiments, the wireless device is configured by the network node with at least one CQI correction parameter that is used for correcting at least one CQI value reported to the network node.

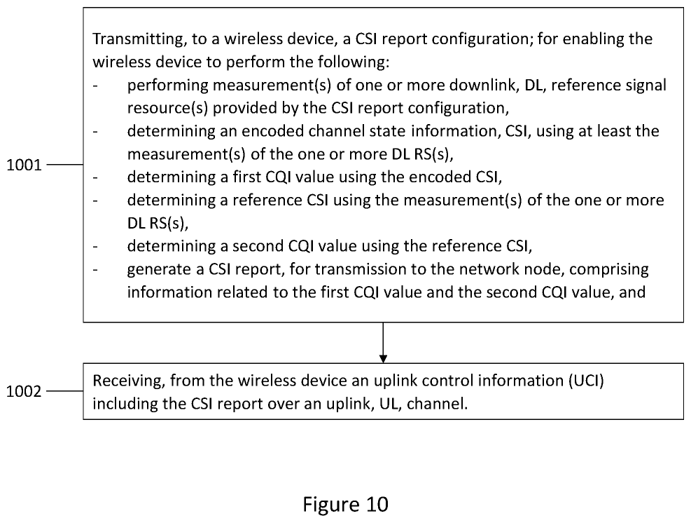

Referring to FIG. 10, there is illustrated another method performed by a network node 1200 according to some of the previously described embodiments. The method performed by the network node 1200 is used for receiving a CSI report from a wireless device 800. FIG. 10 illustrates the main method steps, which comprise:
transmitting (1001), to a wireless device, a CSI report configuration; for enabling the wireless device to:
   performing measurement(s) of one or more downlink, DL, reference signal resource(s) provided by the CSI report configuration,
   determining an encoded channel state information, CSI, using at least the measurement(s) of the one or more DL RS(s),
   determining a first CQI value using the encoded CSI,
   determining a reference CSI using the measurement(s) of the one or more DL RS(s),
   determining a second CQI value using the reference CSI,
   generate a CSI report for transmission to the network node, the CSI report comprising information related to the first CQI value and the second CQI value, and
receiving (1002), from the wireless device an uplink control information (UCI) including the CSI report over an uplink, UL, channel.

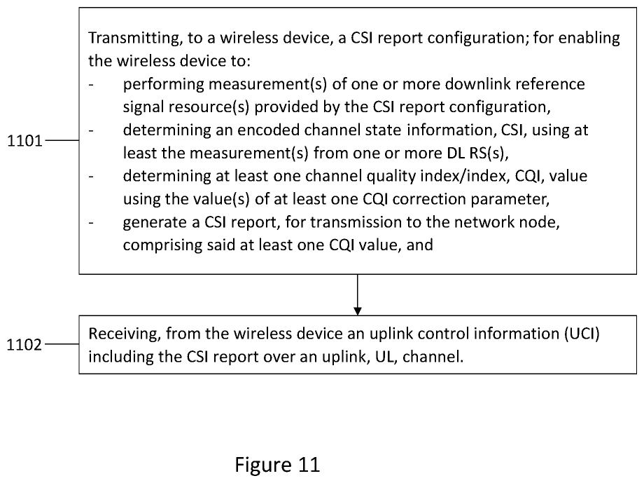

Referring to FIG. 11, there is illustrated another method performed by a network node 1200 according to some of the previously described embodiments. The method performed by the network node 1200 is used for receiving a CSI report from a wireless device 800. FIG. 11 illustrates the main method steps, which comprise:
transmitting (1101), to a wireless device, a CSI report configuration; for enabling the wireless device to:
   performing measurement(s) of one or more downlink reference signal resource(s) provided by the CSI report configuration,
   determining an encoded channel state information, CSI, using at least the measurement(s),
   determining at least one channel quality index/index, CQI, value using the value(s) of at least one CQI correction parameter,
   generate a CSI report for transmission to the network node, the CSI report comprising said at least one CQI value, and
receiving (1102), from the wireless device an uplink control information (UCI) including the CSI report over an uplink, UL, channel.

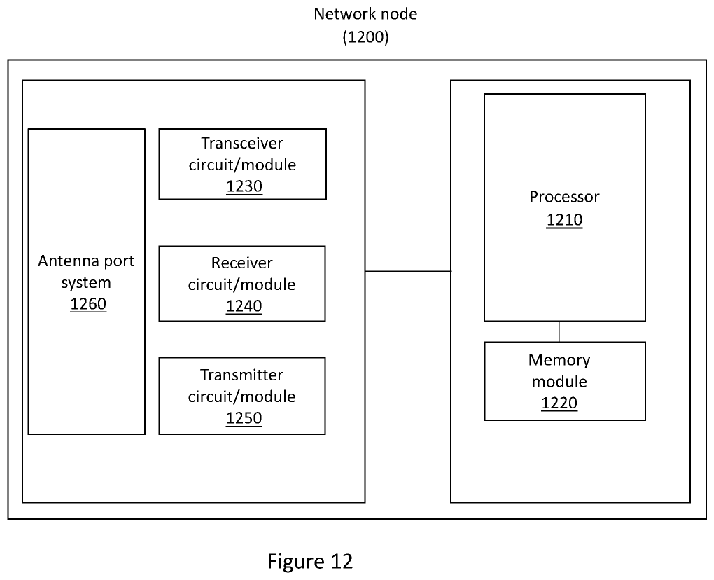

In order to perform the previously described process or method steps performed by the network node there is also provided a network node. FIG. 12 illustrates a block diagram depicting a network node 1200. The network node 1200 comprises a processor 1210 or processing circuit or a processing module or a processor means 1210; a receiver circuit or receiver module 1240; a transmitter circuit or transmitter module 1250; a memory module 1220, a transceiver circuit or transceiver module 1230 which may include the transmitter circuit 1250 and the receiver circuit 1240. The network node 1200 further comprises an antenna system 1260 which includes antenna circuitry for transmitting and receiving signals to/from at least the wireless device. The antenna system employs beamforming as previously described.

The network node 1200 may belong to any radio access technology including 4G or LTE, LTE-A, 5G, advanced 5G or a combination thereof that support beamforming technology. The network device comprising the processor and the memory contains instructions executable by the processor, whereby the network node 1200 is operative or is configured to perform any one of the embodiments related to the network node 1200 as previously described.

The processing module/circuit 1210 includes a processor, microprocessor, an application specific integrated circuit (ASIC), field programmable gate array (FPGA), or the like, and may be referred to as the “processor.” The processor 1210 controls the operation of the network node and its components. Memory (circuit or module) 1220 includes a random-access memory (RAM), a read only memory (ROM), and/or another type of memory to store data and instructions that may be used by processor 1210. In general, it will be understood that the network node in one or more embodiments includes fixed or programmed circuitry that is configured to carry out the operations in any of the embodiments disclosed herein.

In at least one such example, the processor 1210 includes a microprocessor, microcontroller, DSP, ASIC, FPGA, or other processing circuitry that is configured to execute computer program instructions from a computer program stored in a non-transitory computer-readable medium that is in or is accessible to the processing circuitry. Here, “non-transitory” does not necessarily mean permanent or unchanging storage, and may include storage in working or volatile memory, but the term does connote storage of at least some persistence. The execution of the program instructions specially adapts or configures the processing circuitry to carry out the operations disclosed in this disclosure relating to the wireless device. Further, it will be appreciated that the wireless device 1200 may comprise additional components. The network node 1200 may also be viewed as a Transmitter and Receiver Point (TRP).

The network node 1200 by means of processor 1210 executes instructions contained in the memory 1220 whereby the network node 1200 is operative to perform any one of the previously described embodiments related to the actions performed by the network node, some of which are presented in appended method claims 21-23.

There is also provided a computer program comprising instructions which when executed by the processor 1210 of the network node cause the processor 1210 to carry out the method according to any one of claim 21-23.

Several advantages of the described embodiments in this disclosure are achieved as previously described and which include significantly reducing the feedback overhead and the computational complexity at the wireless device for CSI reporting. Another advantage is to reduce latency in the CSI reporting.

Reference throughout this specification to “an example” or “exemplary” means that a particular feature, structure, or characteristic described in connection with the example is included in at least one embodiment of the present technology. Thus, appearances of the phrases “in an example” or the word “exemplary” in various places throughout this specification are not necessarily all referring to the same embodiment.

Throughout this disclosure, the word “comprise” or “comprising” has been used in a non-limiting sense, i.e. meaning “consist at least of”. Although specific terms may be employed herein, they are used in a generic and descriptive sense only and not for purposes of limitation. The embodiments herein may be applied in any wireless systems including LTE or 4G, LTE-A (or LTE-Advanced), 5G, advanced 5G, WiMAX, WiFi, satellite communications, TV broadcasting etc.

1. A method performed by a wireless device for channel state information, CSI, reporting, in a wireless communication system, the method comprising
receiving, from a network node or another wireless device, a channel state information, CSI, report configuration,
performing measurement(s) of one or more downlink reference signal resource(s) provided by the CSI report configuration,
determining an encoded channel state information, CSI, using at least said measurement(s),
determining a decoded CSI corresponding to said encoded CSI,
determining at least one CQI value calculated using said decoded CSI, and ∘ transmitting to the network node or to said another wireless device, a CSI report comprising said at least one CQI value.

2. A method performed by a wireless device for channel state information, CSI, reporting, in a wireless communication system, the method comprising
receiving, from a network node or another wireless device, a channel state information, CSI, report configuration,
performing measurement(s) of one or more downlink, DL, reference signal resource(s) provided by the CSI report configuration,
determining an encoded channel state information, CSI, using at least the measurement(s) of the one or more DL RS(s),
determining a first CQI value using the encoded CSI,
determining a reference CSI using the measurement(s) of the one or more DL RS(s),
determining a second CQI value using the reference CSI,
reporting or transmitting to a network node or another wireless device, a CSI report comprising information related to the first CQI value and the second CQI value.

3. A method performed by a wireless device for channel state information, CSI, reporting, in a wireless communication system, the method comprising
receiving, from a network node or another wireless device, a channel state information, CSI, report configuration,
performing measurement(s) of one or more downlink reference signal resource(s) provided by the CSI report configuration,
determining an encoded channel state information, CSI, using at least the measurement(s) from one or more DL RS(s),
determining at least one channel quality index/index, CQI, value using the value(s) of at least one CQI correction parameter,
transmitting to the network node or another wireless device, a CSI report comprising said at least one CQI value.

4. The method according to claim 1, wherein the encoded CSI corresponds to or represents a channel/precoder vector or matrix or multiple channel/precoder vectors/matrices corresponding to a number of subbands within a CSI reporting band.

5. The method according to claim 1, wherein the encoded CSI is determined by a CSI encoder, wherein the CSI encoder comprises an AI/ML model or a neural network.

6. The method according to claim 5, wherein the CSI encoder comprises a part of a two-sided neural network such as an auto-encoder for CSI encoding.

7. The method according to claim 1, wherein a decoded CSI corresponds to channel/precoder matrix (matrices) or vector(s), and is determined by a CSI decoder using the encoded CSI.

8. The method according to claim 1, wherein the CSI decoder comprises an AI/ML model or a neural network.

9. The method according to claim 1, wherein the CSI decoder comprises a decoder part of a two-sided neural network such as an auto-encoder for CSI decoding.

10. The method according to claim 9, wherein the encoder part of said auto-encoder is used by the wireless device to determine the encoded CSI.

11. The method according to claim 1, wherein the wireless device employs or supports one or more CSI decoders used to determine the decoded CSI, and selects a CSI decoder for the CQI calculation from a plurality of CSI decoders.

12. The method according to claim 11, wherein each CSI decoder is associated with an identifier.

13. The method according to claim 1, wherein the wireless device reports information related to the CSI decoder used to calculate the CQI value(s) to the network node or another wireless device.

14. The method according to claim 13, wherein the information regarding the CSI decoder comprises at least one of the following:
an identifier of the CSI decoder used for the computation of at least one CQI value in a CSI report,
at least one index or at least one value that is associated with the performance of the CSI decoder in the reconstruction/decoding of the encoded CSI,
any information relating to the structure or processing of the CSI decoder, for e.g., preprocessing or post-processing steps used before or after the processing using an AI/ML model, at least one of the following parameters used by a neural network in the decoder: the number of layers, the types of one or more layers, the dimensions of the inputs/outputs across one or more layers and/or the parameters of at least one layer.

15. The method according to claim 1, wherein the CSI report comprises said encoded CSI.

16. The method according to claim 2, wherein the reference CSI indicates a reference precoding information comprising a linear combination of basis vectors selected from a first basis set and a second basis set, and a set of linear combination coefficients to form one or more precoding matrices corresponding to at least a subband in a CSI reporting band.

17. The method according to claim 2, wherein the encoded CSI and the reference CSI are obtained/based on the measurements on the same downlink reference signal resource(s).

18. The method according to claim 3, wherein the method comprises:
determining a decoded CSI corresponding to said encoded CSI,
determining at least one channel quality index/index, CQI, value using the value(s) of at least one CQI correction parameter and said decoded CSI, and
transmitting to the network node or any other communication entity a CSI report, that comprises said at least one CQI value.

19. The method according to claim 18, wherein the CQI correction parameter is one of the following:
a parameter that denotes the accuracy or error in the reconstruction of the CSI that decodes the encoded CSI,
a parameter that denotes a ‘confidence measure’ of the CSI obtained from the decoding neural network employed at the entity receiving the CSI report,
a parameter that is employed in an expression for the determination of a precoder matrix or precoder matrices used for the calculation of at least one CQI value.

20. The method according to claim 3, the wireless device is configured by the network node with at least one CQI correction parameter that is used for correcting at least one CQI value reported to the network node.

21. A method performed by a network node for receiving, from a wireless device, a channel state information, CSI, report in a wireless communication system, the method comprising:
transmitting, to the wireless device, a CSI report configuration; for enabling the wireless device to:
performing measurement(s) of one or more downlink reference signal resource(s) provided by the CSI report configuration,
determining an encoded channel state information, CSI, using at least said measurement(s),
determining a decoded CSI corresponding to said encoded CSI,
determining at least one CQI value calculated using said decoded CSI, and
generate a CSI report for transmission to the network node comprising said at least one CQI value.
receiving, from the wireless device an uplink control information (UCI) including the CSI report over an uplink, UL, channel.

22. A method performed by a network node for receiving, from a wireless device, a channel state information, CSI, report in a wireless communication system, the method comprising:
transmitting, to the wireless device, a CSI report configuration; for enabling the wireless device to:
performing measurement(s) of one or more downlink, DL, reference signal resource(s) provided by the CSI report configuration,
determining an encoded channel state information, CSI, using at least the measurement(s) of the one or more DL RS(s),
determining a first CQI value using the encoded CSI,
determining a reference CSI using the measurement(s) of the one or more DL RS(s),
determining a second CQI value using the reference CSI,
generate a CSI report for transmission to the network node, the CSI report comprising information related to the first CQI value and the second CQI value, and
receiving, from the wireless device an uplink control information (UCI) including the CSI report over an uplink, UL, channel.

23. A method performed by a network node for receiving, from a wireless device, a channel state information, CSI, report in a wireless communication system, the method comprising:
transmitting, to the wireless device, a CSI report configuration; for enabling the wireless device to:
performing measurement(s) of one or more downlink reference signal resource(s) provided by the CSI report configuration,
determining an encoded channel state information, CSI, using at least the measurement(s) from one or more DL RS(s),
determining at least one channel quality index/index, CQI, value using the value(s) of at least one CQI correction parameter,
generate a CSI report for transmission to the network node, the CSI report comprising said at least one CQI value, and
receiving, from the wireless device an uplink control information (UCI) including the CSI report over an uplink, UL, channel.

24. A wireless device comprising a processor and a memory containing instructions executable by said processor, whereby the wireless device is operative to perform the method of claim 1.

25. A network node comprising a processor and a memory containing instructions executable by said processor, whereby the network node is operative to perform the method of claim 21.
